(19) United States
(12) Patent Application Publication
(10) Pub. No.: US 2019/0305632 A1
(43) Pub. Date: Oct. 3, 2019

(54) MACHINE FOR MANUFACTURING CABLES

(71) Applicant: CONSTRUCCIONES MECANICAS CABALLE, S.A., BADALONA (BARCELONA) (ES)

(72) Inventor: ANTONIO BERENGUER ATENZA, BADALONA (BARCELONA) (ES)

(21) Appl. No.: 16/275,163

(22) Filed: Feb. 13, 2019

(30) Foreign Application Priority Data
Apr. 3, 2018 (EP) 18382226.1

(51) Int. Cl. H02K 5/22; B21B 1/16; H01B 13/00

(52) U.S. Cl. CPC H02K 5/22; H01B 13/0036; B21B 1/16

(57) ABSTRACT

A machine for manufacturing cables includes a rotor tube inside which is a motor. The machine also includes four rods attached to the tube. The rods are arranged so as to follow secant lines of the wall of the tube and include two mutually parallel plates. Each plate is connected to the four rods. The four rods are arranged such that they exert a force on the wall of the tube towards the inside of the tube in order to compensate for the effect of centrifugal force. The motor is positioned between the plates.

### CROSS-REFERENCE TO RELATED APPLICATIONS

This application claims priority to European Patent Application No. 18382226.1 filed on Apr. 3, 2018, the disclosure of which including the specification, the drawings, and the claims is hereby incorporated by reference in its entirety.

### FIELD OF THE INVENTION

The present invention relates to a machine for manufacturing cables. More specifically, the present invention relates to a motor arrangement of said machine.

### BACKGROUND OF THE INVENTION

Machines for manufacturing cables comprise a rotary tube, inside which is a motor. The attachment of the motor must withstand the high stresses produced by centrifugal forces, secure the yoke pieces of the motor itself such that said motor does not have to endure the centrifugal forces of the yoke pieces thereof or endure the gyroscopic torque resulting from the fact that the rotation of the tube, in which the motor (rotor) is located, and the rotation of the motor are produced on mutually perpendicular axes.

### SUMMARY OF THE INVENTION

An object of the present invention is to disclose improved attachment of the motor in this type of machine, which makes it possible to increase the performance of the machine, for example to increase the nominal rotational speed of the tube or rotor, or the diameter thereof, or reduce the thickness of the rotor tube.

For this purpose, the present invention discloses a machine for manufacturing cables which comprises a rotor tube inside which is a motor, wherein the machine comprises four rods attached to the tube, the rods being arranged so as to follow secant lines of the wall of the tube and comprising two parallel plates, each plate being connected to the four rods, the four rods being arranged such that they exert a force on the wall of the tube towards the inside of the tube in order to compensate for the effect of the centrifugal force, the motor being positioned between said plates.

This arrangement makes it possible to successfully attach the motor, making it possible to secure the yoke pieces without the motor itself having to endure the centrifugal forces on the yoke pieces thereof, since by placing the motor between the plates, the yoke pieces are secured, and therefore the motor is not required to endure its own centrifugal forces. The preloading compensates for the effect of the centrifugal force on the rods, which tends to stretch said rods, resulting in deformation of the rotor tube, and/or in the separation of the reinforcement rings from the tube and putting at risk the attachment of the motor and/or the structural integrity of the assembly. In turn, the rods prevent expansion of the rotor tube and adjacent elements caused by the same centrifugal force.

Preferably, the rods are screwed through the outside of the rotor tube. More preferably, they are screwed onto a reinforced zone of the wall of the tube.

Advantageously, the four rods are arranged so as to be mutually parallel. More advantageously, the rods are arranged in a rectangular arrangement.

Preferably, the tube comprises at least one reinforcement ring on the outside of the rotor tube, and more preferably comprises at least two. Preferably, each rod is screwed onto a reinforcement ring, such that said force is exerted by the rods on the relevant reinforcement ring. In this way, the preloading produced by the rods compensates for the expansion of the rings produced by the centrifugal force generated by the rotation of the rotor tube.

Preferably, the machine comprises crossbars, as safety elements, which connect said plates. Preferably, there are four of said crossbars.

### BRIEF DESCRIPTION OF THE DRAWINGS

To aid understanding, an explanatory yet non-limiting drawing is included of an embodiment of the machine according to the invention.

FIG. 1 shows a cross section of the rotor tube of a machine according to the present invention, an embodiment of an arrangement of the motor of said machine being visible.

### DETAILED DESCRIPTION OF THE PREFERRED EMBODIMENTS

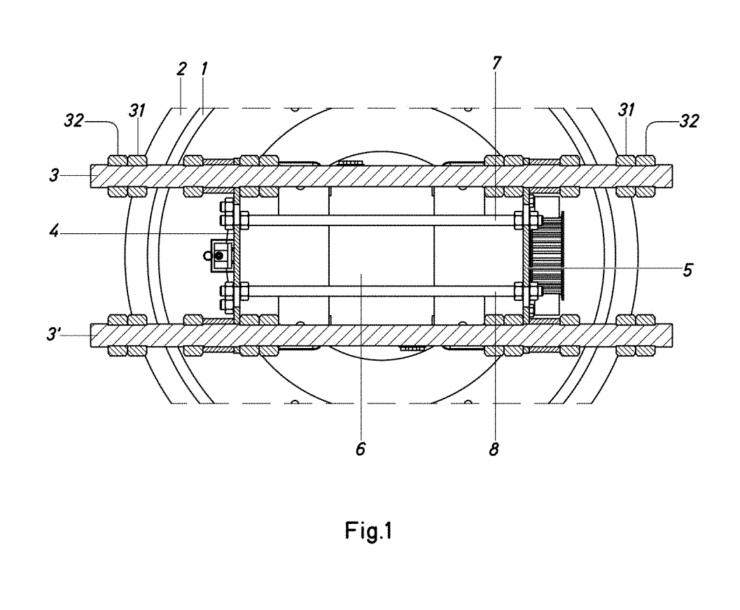

In the figure, an embodiment is shown in which four rods have been arranged so as to be connected to the tube in a rectangular arrangement, all of said rods being mutually parallel. FIG. 1 shows a section transverse to the axis of the rotor tube -1- at the level of two of the rods, which is why only two rods -3-, -3′- are visible.

In this embodiment, there are two reinforcement rings -2- (in the figure only one is visible, corresponding to the attachment of two rods -3-, -3′-). Said rings -2- are arranged on the outside of the tube and rigidify the wall.

The threaded rods -3-, -3′- are arranged so as to follow a secant direction with respect to the wall of the rotor tube -1-, and more specifically, in this case, secant with respect to the cross section of the wall of the rotor tube -3-, -3′-. The rods are attached, in this case, by means of a nut and locknut -31-, -32-. The rods -3-, -3′- are attached on the rings -2-, preloading said rings, thus compensating for the centrifugal force, which has the tendency to expand the rings.

The plates -4-, -5- are attached to the rods -3-, -3′-. The motor -6- is positioned between the plates -4-, -5-. In this way, the yoke pieces of the motor are secured and the motor does not have to endure its own centrifugal forces.

As a safety element, four crossbars -7-, -8- have been positioned in a rectangular arrangement, connecting the two plates -4-, -5-.

Although the invention has been set out and described with reference to embodiments thereof, it should be understood that these do not limit the invention, and that it is possible to alter many structural or other details that may prove obvious to persons skilled in the art after interpreting the subject matter disclosed in the present description, claims and drawings. Therefore, the scope of the present invention includes any variant or equivalent that could be considered covered by the broadest scope of the following claims.

What is claimed is:

1. A machine for manufacturing cables comprising:
a rotor tube inside which is a motor,
four rods attached to the tube, the rods being arranged so as to follow secant lines of the wall of the tube, and
two mutually parallel plates each plate being connected to the four rods,
wherein the four rods are arranged such that they exert a force on the wall of the tube towards the inside of the tube in order to compensate for the effect of the centrifugal force, and
the motor is positioned between said plates.

2. The machine according to claim 1, wherein the rods are screwed through the outside of the rotor tube.

3. The machine according to claim 1, wherein the rods are screwed onto a reinforced zone of the wall of the tube.

4. The machine according to claim 2, wherein each rod is screwed onto a reinforcement ring, such that said force is exerted by the rods on the relevant reinforcement ring.

5. The machine according to claim 1, wherein the rods are arranged so as to be mutually parallel.

6. The machine according to claim 5, wherein the rods are arranged in a rectangular arrangement.

7. The Machine according to claim 5, wherein the plates are arranged perpendicularly to the rods.

8. The machine according to claim 1, wherein the yoke pieces of the motor are attached to the plates.

9. The machine according to claim 1, wherein crossbars are provided which connect the two plates.

10. The machine according to claim 9, wherein four crossbars are provided.
